(19) United States
(12) Patent Application Publication
(10) Pub. No.: US 2020/0402720 A1
(43) Pub. Date: Dec. 24, 2020

(54) EMBEDDED THIN FILM CAPACITOR WITH NANOCUBE FILM AND PROCESS FOR FORMING SUCH

(71) Applicant: Intel Corporation, Santa Clara, CA (US)

(72) Inventors: Brandon C. MARIN, Chandler, AZ (US); Andrew J. BROWN, Gilbert, AZ (US); Kristof DARMAWIKARTA, Chandler, AZ (US); Jeremy ECTON, Gilbert, AZ (US); Suddhasattwa NAD, Chandler, AZ (US)

(21) Appl. No.: 16/447,877

(22) Filed: Jun. 20, 2019

(51) Int. Cl. H01G 4/33; H01G 4/12

(52) U.S. Cl. CPC H01G 4/33; C04B 35/4682; H01G 4/1227

(57) ABSTRACT

A device is disclosed. The device includes a first insulating film structure, a plurality of conductor layers above the first insulating film structure, a Ti structure and a nanocube structure between respective layers of the plurality of conductor layers, the nanocube structure above the Ti structure, and a second insulating film structure above a topmost conductor layer of the plurality of conductor layers.

### TECHNICAL FIELD

Embodiments of the disclosure pertain to embedded thin film capacitors and, in particular, embedded thin film capacitors with nanocube films.

### BACKGROUND

Passives components (such as resistors, inductors, and capacitors) are used in semiconductor packaging for the modulation, conversion, and storage of electrical signals. Methods of adding passive components to semiconductor packages primarily involve the fabrication of discrete passive components which are either mounted onto the first layer interconnect (FLI) layer of the package or implanted into buildup layers during the build-up process. For example, methods of adding passive components to semiconductor packages can involve the placement of pre-assembled capacitors onto the surface of the packages or the embedding of pre-assembled capacitors into buildup layers of the packages. However, these methods are inherently limited with regard to the density of components that can be added to a semiconductor package.

An industry objective is to achieve a passive component density that surpasses 20-30 passive devices per square centimeter. However, this objective is complicated by current methods that limit the placement of passive components to surface layers. Additionally, increasing performance requirements for capacitors add to the cost of pre-assembling passive devices prior to their addition to the package. It should be appreciated that as design rules shrink in semiconductor packaging, so does the availability of space for discrete passive components.

### BRIEF DESCRIPTION OF THE DRAWINGS

FIG. 1 illustrates multiple embedded thin-film capacitors with nanocube films according to an embodiment.

FIGS. 2A-2J illustrate cross-sections of a thin-film capacitor structure during a process for forming an embedded thin film capacitor with a nanocube film according to an embodiment.

FIGS. 3A-3F illustrate cross-sections of a structure during a process for forming multiple embedded thin film capacitors with nanocube films according to an embodiment.

FIG. 4 illustrates a table of example capacitances per unit area for a sample geometry according to an embodiment.

FIG. 5 illustrates the morphology and structure of nanocube material according to an embodiment.

FIGS. 6A-6K illustrate cross-sections of a thin film capacitor structure during a process for forming an embedded thin film capacitor with a nanocube film according to an embodiment.

FIG. 7 illustrates a flowchart of a method for forming an embedded thin film capacitor that includes a nanocube film according to an embodiment.

FIG. 8 illustrates a computer system according to an embodiment.

### DESCRIPTION OF THE EMBODIMENTS

Embedded thin film capacitors with nanocube films are described. In the following description, numerous specific details are set forth, such as specific integration and material regimes, in order to provide a thorough understanding of embodiments of the present disclosure. It will be apparent to one skilled in the art that embodiments of the present disclosure may be practiced without these specific details. In other instances, well-known features, such as integrated circuit design layouts, are not described in detail in order to not unnecessarily obscure embodiments of the present disclosure. Furthermore, it is to be appreciated that the various embodiments shown in the Figures are illustrative representations and are not necessarily drawn to scale.

Certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Passives components (such as resistors, inductors, and capacitors) are used in semiconductor packaging for the modulation, conversion, and storage of electrical signals. Methods of adding passive components to semiconductor packages primarily involve the fabrication of discrete passive components which are either mounted onto the first layer interconnect (FLI) layer of the package or implanted into buildup layers during the build-up process. For example, methods of adding passive components to semiconductor packages can involve the placement of pre-assembled capacitors onto the surface of the packages or the embedding of pre-assembled capacitors into buildup layers of the packages. However, these methods are inherently limited with regard to the density of components that can be added to a semiconductor package.

An industry objective is to achieve a passive component density that surpasses 20-30 passive devices per square centimeter. However, this objective is complicated by current methods that limit the placement of passive components to surface layers. Additionally, increasing performance requirements for capacitors add to the cost of pre-assembling passive devices prior to their addition to the package. It should be appreciated that as design rules shrink in semiconductor packaging, so does the availability of space for discrete passive components.

An approach that addresses the shortcomings of previous approaches is disclosed and described herein. For example, as part of a disclosed process, an embedded thin film capacitor (TFC) is formed by electrolessly growing BaTiO₃ nanocubes on a lithographically defined, physical vapor deposition (PVD) patterned titanium film. The resultant structure is an embedded, parallel-plate TFC that maximizes functionality of a single Ajinomoto build-up film (ABF) layer. In an embodiment, a low-temp electroless process is used to synthesize nanocube material, e.g., BaTiO₃ nanocubes, insitu and fabricate a unique, inexpensive, structure, e.g., an embedded, parallel-plate type TFC. In an embodiment, single-crystal nanocubes are grown on the substrate using a low-temp electroless process. Additionally, the process can be applied to fabricating multiple TFCs on top of each other (series capacitors) to amplify capacitance.

In an embodiment, the nanocubes are single-crystalline films. The single-crystalline films have an inherently higher permittivity as compared to spark-sintered titanate films. In an embodiment, the capacitance of a single TFC formed as described herein can exceed 2.93 μF/cm². Furthermore, this level of capacitance is even more readily attainable when the TFCs are fabricated in series as is described herein. Additionally, as regards cost, in an embodiment, a low-temperature wet method to deposit high-k films can be used to considerably lower the cost of fabricating embedded TFCs. Accordingly, in an embodiment, the aforementioned characteristics help to provide higher performance and lower cost components.

In an embodiment, a process for forming an embedded TFC by electroless growth of nanocube material on a patterned titanium film is described. In an embodiment, the TFC is formed on the package, thus lowering the cost of assembling a discrete capacitor separately and subsequently embedding it in the package. In an embodiment, a titanium substrate is placed in a solution of BaCO₃, NaOH and KOH with the Na/K precisely tuned at a 51.5:48.5 ratio. In other embodiments, the solution of BaCO₃, NaOH and KOH can have the Na/K precisely tuned at other ratios. The solution is then heated and the BaTiO₃ nanocubes are grown onto the titanium substrate. In an embodiment, an advantage of the method is that the nanocube material is comprised of nanocrystalline material, which has a much higher κ-value (100-7000) than its amorphous counterpart. In an embodiment, a maximum κ-value of 2000 can be used. In other embodiments, another maximum value greater than or less than 2000 can be used.

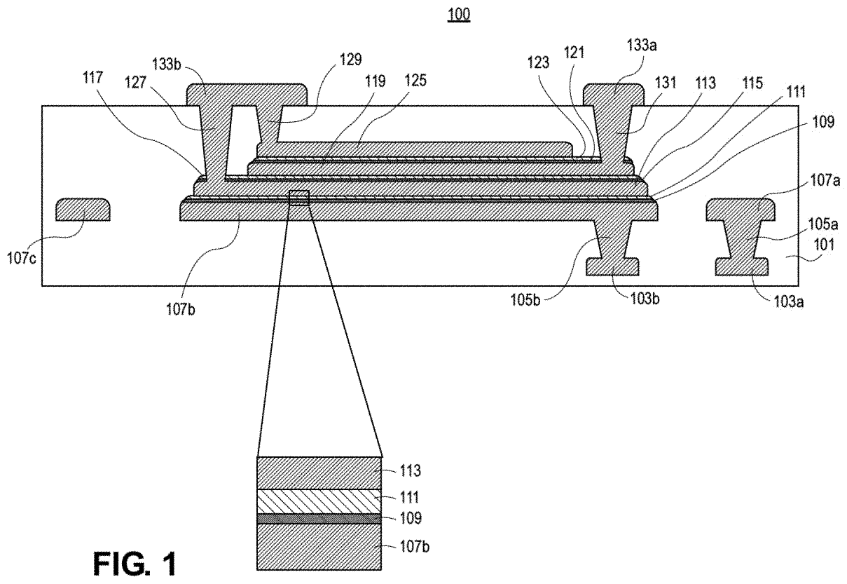

FIG. 1 illustrates multiple embedded thin-film capacitors 100 according to an embodiment. In an embodiment, the multiple embedded thin-film capacitors 100 are formed in series. In an embodiment, the multiple embedded thin-film capacitors 100 can include insulating film structure 101, conductor 103a, conductor 103b, conductor via 105a, conductor via 105b, conductor 107a, conductor plate 107b, conductor 107c, titanium film 109, nanocube structure 111, conductor plate 113, titanium film 115, nanocube structure 117, conductor plate 119, titanium film 121, nanocube structure 123, conductor plate 125, conductor via 127, conductor via 129, conductor via 131, conductor 133a and conductor 133b.

Referring to FIG. 1, in an embodiment, the conductor 103a can be formed in the insulating film structure 101. In an embodiment, the conductor 103b can be formed in the insulating film structure 101. In an embodiment, the conductor 107a can be formed in the insulating film structure 101. In an embodiment, the conductor 107c can be formed in the insulating film structure 101. In an embodiment, the conductor plate 107b can be formed in the insulating film structure 101. In an embodiment, the conductor via 105a can be formed in a layer of the insulating film structure 101 and can extend between conductor 103a and conductor 107a. In an embodiment, the conductor via 105b can be formed in the insulting film structure 101 and can extend between conductor 103b and conductor plate 107b. In an embodiment, the titanium film 109 can be formed on the conductor plate 107b. In an embodiment, the nanocube structure 111 can be formed on the titanium film 109. In an embodiment, the conductor plate 113 can be formed above the nanocube structure 111. In an embodiment, the titanium film 115 can be formed on the conductor plate 113. In an embodiment, the nanocube structure 117 can be formed on the titanium film 115. In an embodiment, the conductor plate 119 can be formed on the nanocube structure 117. In an embodiment, the titanium film 121 can be formed on the conductor plate 119. In an embodiment, the nanocube structure 123 can be formed on the titanium film 121. In an embodiment, the conductor plate 125 can be formed on the nanocube structure 123. In an embodiment, the conductor via 127 can be formed in the build-up material of the insulating film structure 101 and can extend between the conductor plate 113 and the conductor 133b. In an embodiment, the conductor via 129 can be formed in a layer of the insulating film structure 101 and can extend between the conductor plate 125 and the conductor 133b. In an embodiment, the conductor via 131 can be formed in the insulating film structure 101 and can extend between the conductor plate 119 and the conductor 133a. In an embodiment, the conductor 133a can be formed on the surface of the insulating film structure 101. In an embodiment, the conductor 133b can be formed on the surface of the insulating film structure 101.

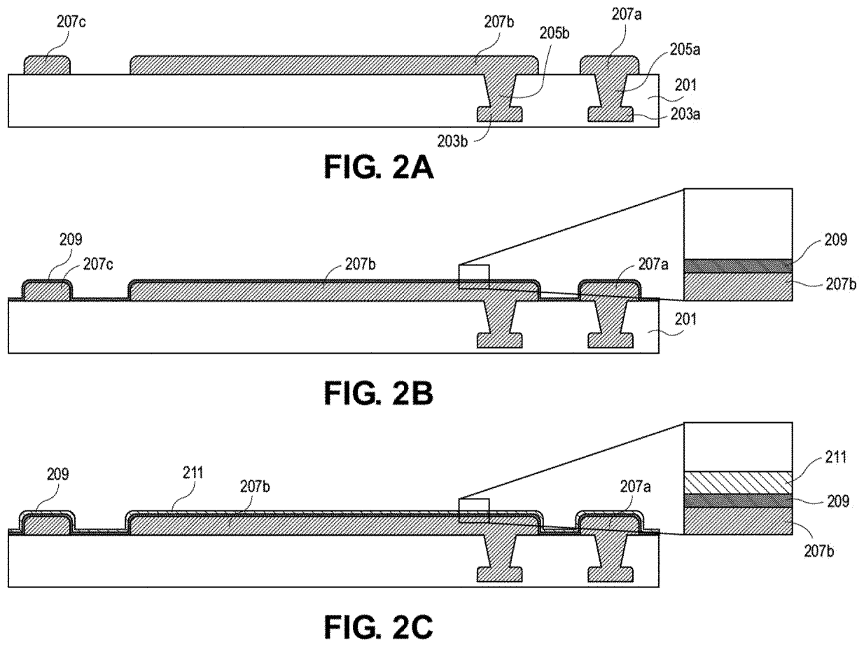

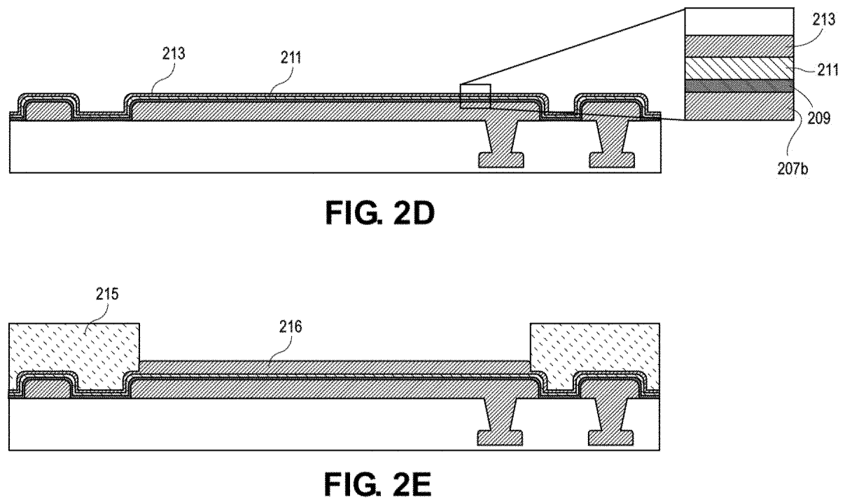

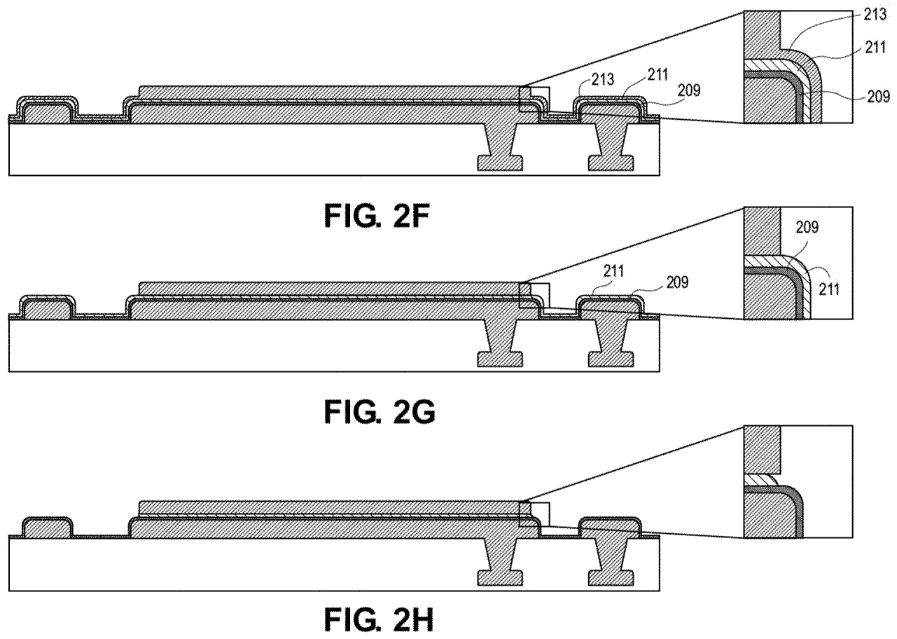

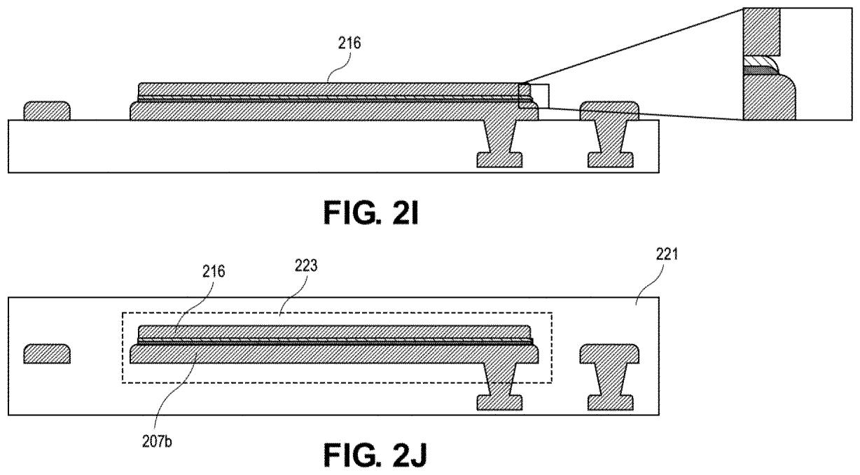

In an embodiment, the titanium films 109, 115 and 121 and the nanocube structures 111, 117 and 123 between conductor plates 107b, 113, 119 and 125 can include an undercut region as shown in FIG. 2I. In an embodiment, the width of the respective conductor plates 107b, 113, 119 and 125 can decrease in the direction from bottom to top. In an embodiment, the width of the respective conductor plates 107b, 113, 119 and 125 can decrease by at least 5-500 micrometers in the direction from bottom to top. In an embodiment, the thin film capacitors of thin-film capacitors 100 can have a capacitance between 2.93 uF/cm² and 11.75 uF/cm². In an embodiment, the nanocube structures 111, 117 and 123 can have a permittivity that is greater than 5000. In an embodiment, the nanocube structures 111, 117 and 123 can have a thickness of 100-1400 nm.

In an embodiment, the insulating film structure 101 can be formed from ABF material. In other embodiments, the insulating film structure 101 can be formed from other materials. In an embodiment, the conductor 103a can be formed from copper. In other embodiments, the conductor 103a can be formed by other materials. In an embodiment, the conductor 103b can be formed from copper. In other embodiments, the conductor 103b can be formed from other materials. In an embodiment, the conductor via 105a can be formed from copper. In other embodiments, the conductor via 105a can be formed from other materials. In an embodiment, the conductor via 105b can be formed from copper. In other embodiments, the conductor via 105b can be formed from other materials. In an embodiment, the conductor 107a can be formed from copper. In other embodiments, the conductor 107a can be formed from other materials. In an embodiment, the conductor plate 107b can be formed from copper. In other embodiments, the conductor plate 107b can be formed from other materials. In an embodiment, the conductor 107c can be formed from copper. In other embodiments, the conductor 107c can be formed from other materials. In an embodiment, the nanocube structure 111 can be formed from BaTiO₃. In other embodiments, the nanocube structure 111 can be formed from other material. In an embodiment, the conductor plate 113 can be formed from copper. In other embodiments, the conductor plate 113 can be formed from other materials. In an embodiment, the nanocube structure 117 can be formed from BaTiO₃. In other embodiments, the nanocube structure 117 can be formed from other materials. In an embodiment, the conductor plate 119 can be formed from copper. In other embodiments, the conductor plate 119 can be formed from other materials. In an embodiment, the nanocube structure 123 can be formed from BaTiO₃. In other embodiments, the nanocube structure 123 can be formed from other materials. In an embodiment, the conductor plate 125 can be formed from copper. In other embodiments, the conductor plate 125 can be formed from other materials. In an embodiment, the conductor via 127 can be formed from copper. In other embodiments, the conductor via 127 can be formed from other materials. In an embodiment, the conductor via 129 can be formed from copper. In other embodiments, the conductor via 129 can be formed from other materials. In an embodiment, the conductor via 131 can be formed from copper. In other embodiments, the conductor via 131 can be formed from other materials. In an embodiment, the conductor 133a can be formed from copper. In other embodiments, the conductor 133a can be formed from other materials. In an embodiment, the conductor 133b can be formed from copper. In other embodiments, the conductor 133b can be formed from other materials.

In an embodiment, the multiple embedded thin-film capacitors 100 with nanocube films of FIG. 1, can be fabricated in parallel with traditional build-up semi-additive processes (SAP) and can be used to increase passive component density which: (1) reduces electrical loss, and (2) increases package functionality.

FIGS. 2A-2J illustrate cross-sections of a thin-film capacitor structure during a process for forming an embedded thin film capacitor according to an embodiment. Referring to FIG. 2A, subsequent to one or more operations, the structure includes insulating film structure 201, conductor layer 203a, conductor layer 203b, conductor via 205a, conductor via 205b, conductor layer 207a, conductor plate 207b, and conductor layer 207c.

Referring to FIG. 2B, subsequent to one or more operations that result in the cross-section shown in FIG. 2A, a blanket layer of titanium 209 is formed above the conductor layer 207a, the conductor plate 207b and the conductor layer 207c. In an embodiment, the blanket layer of titanium 209 can be formed by sputtering. In other embodiments, the blanket layer of titanium 209 can be formed by atomic layer deposition (ALD), physical vapor deposition (PVD), chemical vapor deposition (CVD), electrochemical deposition (ECD), or molecular beam epitaxy (MBE). In still other embodiments, the blanket layer of titanium 209 can be formed in other manners.

Referring to FIG. 2C, subsequent to one or more operations that result in the cross-section shown in FIG. 2B, a BaTiO₃ nanocube layer 211 is formed on the layer of Ti 209. In an embodiment, the BaTiO₃ nanocube layer 211 can be formed by electroless deposition. In other embodiments, the BaTiO₃ nanocube layer 211 can be formed by atomic layer deposition (ALD), physical vapor deposition (PVD), chemical vapor deposition (CVD), electrochemical deposition (ECD), or molecular beam epitaxy (MBE). In still other embodiments, the BaTiO₃ nanocube layer 211 can be formed in other manners.

Referring to FIG. 2D, subsequent to one or more operations that result in the cross-section shown in FIG. 2C, a blanket conductor layer 213 is formed on the BaTiO₃ nanocube layer 211. In an embodiment, the blanket conductor layer 213 can be formed from copper. In other embodiments, the blanket conductor layer 213 can be formed from other materials. In an embodiment, the blanket conductor layer 213 can be formed by sputtering or by electroless deposition. In other embodiments, the blanket conductor layer 213 can be formed by atomic layer deposition (ALD), physical vapor deposition (PVD), chemical vapor deposition (CVD), electrochemical deposition (ECD), or molecular beam epitaxy (MBE). In still other embodiments, the blanket conductor layer 213 can be formed in other manners.

Referring to FIG. 2E, subsequent to one or more operations that result in the cross-section shown in FIG. 2D, a dry film resist (DFR) lamination 215 is formed and a conductor plate 216 is grown to form a pad (additional conductor material is added to the initially formed conductor material). In an embodiment, the conductor plate 216 can be formed from copper. In other embodiments, the conductor plate 216 can be formed from other materials. In an embodiment, the conductor plate 216 can be formed by electrolytic plating. In other embodiments, the growing of the conductor plate 216 can be by atomic layer deposition (ALD), physical vapor deposition (PVD), chemical vapor deposition (CVD), electrochemical deposition (ECD), or molecular beam epitaxy (MBE). In still other embodiments, the conductor plate 216 can be grown in other manners.

Referring to FIG. 2F, subsequent to one or more operations that result in the cross-section shown in FIG. 2E, a dry film resist (DFR) strip is performed. See FIG. 2F enlarged view. In an embodiment, the DFR strip leaves excess blanket conductor layer (seed) 213, titanium 209, and BaTiO₃ nanocube layer 211 material. In an embodiment, the DFR strip can include an immersion process. In other embodiments, the DFR strip can be performed in other manners.

Referring to FIG. 2G, subsequent to one or more operations that result in the cross-section shown in FIG. 2F, a flash etch is performed to remove the exposed seed layer 213. In other embodiments, the etch can include isotropic, anisotropic, plasma etching, ion milling or sputter etching.

Referring to FIG. 2H, subsequent to one or more operations that result in the cross-section shown in FIG. 2G, an etch is performed to remove the BaTiO₃ nanocube layer 211 material. In an embodiment, the etch can include an approximately 15C 1M HCl immersion etch that dissolves the BaTiO₃ nanocube layer 211 material. In other embodiments, the etch can be performed in other manners.

Referring to FIG. 2I, subsequent to one or more operations that result in the cross-section shown in FIG. 2H, an etch is performed to remove the titanium 209 material. In an embodiment, as shown in the enlarged view of FIG. 2I, these operations leave an undercut profile in titanium and nanocube material underneath conductor plate 216. In an embodiment, the etchant includes a peroxide and hydrochloric acid (HCl) mixture. In other embodiments, other types of etchants can be used.

Referring to FIG. 2J, subsequent to one or more operations that result in the cross-section shown in FIG. 2I, an insulating film structure 221 is formed above the TFC 223 (shown in the dashed box), the conductor plate 207b, and the conductor plate 216. In an embodiment, the resultant structure includes an embedded TFC that includes a high-k nanocube layer.

Referring to FIGS. 2A-2I, it should be appreciated that in an embodiment, the process flow begins with a bottom conductor plate 207b, e.g., copper, that includes a pad and its traces already patterned as shown in FIG. 2A. Next, a blanket layer of titanium 209 can be deposited by physical-vapor deposition method (PVD) such as by DC-sputtering or thermal/ebeam evaporation (FIG. 2B). In an embodiment, the titanium layer 209 can be the seed layer for the nanocube growth, e.g., BaTiO₃, in the next operation (alternatively it can serve as a bottom electrode plate for the TFC). Next, the BaTiO₃ nanocube layer 211 can be grown electrolessly throughout the entire layer (FIG. 2C). In an embodiment, cubes of ˜200 nm length can be formed, yielding thicknesses between 600-1200 nm. In an embodiment, a temperature of 200 degrees Celsius under pressure can be used, which is significantly less than some current methods of sintering which use temperatures of 1000 C or more. It should be noted that in an embodiment, the nanocube layer can be continuous (no pinholes or gaps). Next, in an embodiment, a seed layer 213 (e.g., copper) can be either blanket sputtered or electrolessly deposited (FIG. 2D). Next, dry-film resist is laminated, exposed, developed, stripped, and the top conductor plate 216 (5-10 um Cu) can be electrolytically grown (FIG. 2E). In an embodiment, there can be some offset between the top plate and bottom plate (˜10-15 um), but because the TFC area can be large (10-15 mm on each side), this offset can be negligible. In an embodiment, when this operation is over, the TFC is essentially complete, except for the excess seed layers that blanket the film that can remain. In an embodiment, the first seed can be removed using a copper flash etch. Next, in an embodiment, a cool, concentrated HCl dip that selectively removes the nanocube material (FIG. 2G) can be performed. Thereafter, the titanium seed layer can be removed by a selective titanium etch (FIG. 2H). The result is an embedded, fully-assembled TFC with a unique morphology in the high-k dielectric layer. The TFC can then be embedded by lamination of another insulating film structure, e.g., ABF (FIG. 2I).

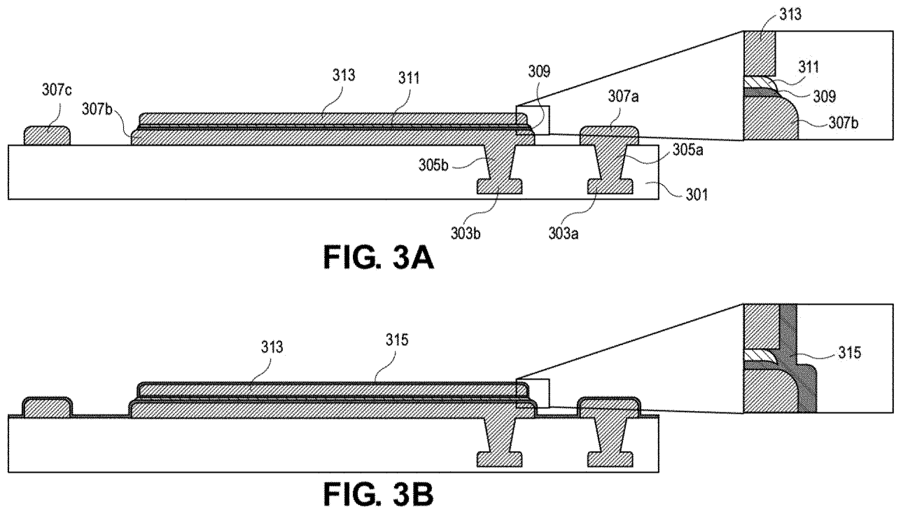

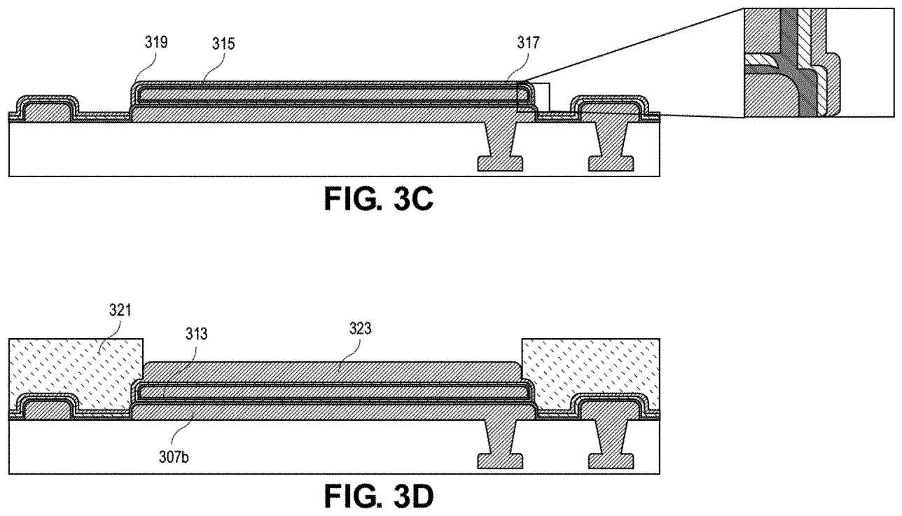

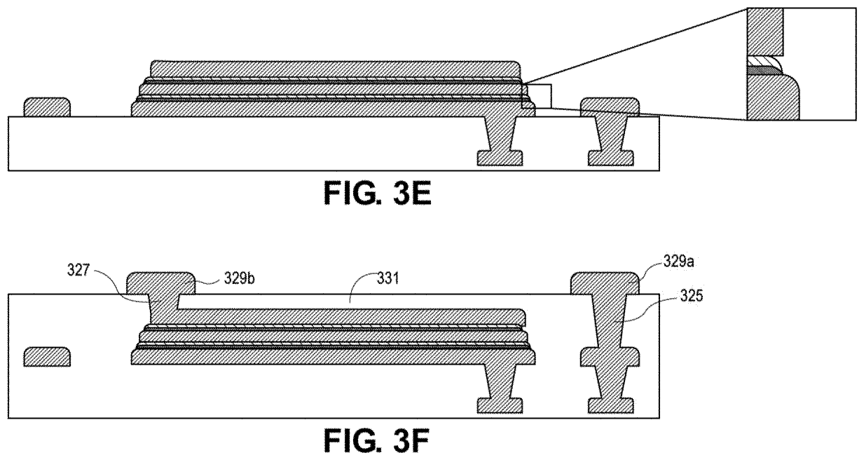

FIGS. 3A-3F illustrate cross-sections of a structure during a process for forming an embedded thin film capacitor structure according to an embodiment.

Referring to FIG. 3A, subsequent to one or more operations, the structure includes insulating film structure 301, conductor layer 303a, conductor layer 303b, conductor via 305a, conductor via 305b, conductor layer 307a, conductor plate 307b, conductor layer 307c, titanium layer 309, nanocube material 311, and conductor plate 313.

Referring to FIG. 3B, subsequent to one or more operations that result in the cross-section shown in FIG. 3A, a titanium layer 315 is formed above the conductor plate 313. In an embodiment, the titanium layer 315 is formed by a sputtering. In other embodiments, the titanium layer 315 can be formed by atomic layer deposition (ALD), physical vapor deposition (PVD), chemical vapor deposition (CVD), electrochemical deposition (ECD), or molecular beam epitaxy (MBE). In still other embodiments, the titanium layer 315 can be formed in other manners.

Referring to FIG. 3C, subsequent to one or more operations that result in the cross-section shown in FIG. 3B, a nanocube layer 317 is formed on the titanium layer 315 and a conductor seed layer 319 is formed on the nanocube layer 317. In an embodiment, the conductor seed layer 319 can include copper. In other embodiments, the conductor seed layer 319 can include other materials. In an embodiment, the titanium layer 315 can be formed by atomic layer deposition (ALD), physical vapor deposition (PVD), chemical vapor deposition (CVD), electrochemical deposition (ECD), or molecular beam epitaxy (MBE). In other embodiments, the titanium layer 315 can be formed in other manners.

In an embodiment, the conductor seed layer 319 can be formed by sputtering. In other embodiments, the conductor seed layer 319 can be formed by atomic layer deposition (ALD), physical vapor deposition (PVD), chemical vapor deposition (CVD), electrochemical deposition (ECD), or molecular beam epitaxy (MBE). In still other embodiments, the conductor seed layer 319 can be formed in other manners.

Referring to FIG. 3D, subsequent to one or more operations that result in the cross-section shown in FIG. 3C, DFR material 321 is formed adjacent the left and right sides of conductor plate 307b and conductor plate 313 to form a space above the conductor seed layer 319. Thereafter, the capacitor top plate 323 is formed above conductor seed layer 319. In an embodiment, the DFR material 321 can be formed by atomic layer deposition (ALD), physical vapor deposition (PVD), chemical vapor deposition (CVD), electrochemical deposition (ECD), or molecular beam epitaxy (MBE). In other embodiments, the DFR material 321 can be formed in other manners. In an embodiment, the conductor top plate 323 can be electrolytically formed. In other embodiments, the conductor top plate 323 can be formed by atomic layer deposition (ALD), physical vapor deposition (PVD), chemical vapor deposition (CVD), electrochemical deposition (ECD), or molecular beam epitaxy (MBE). In still other embodiments, the conductor top plate 323 can be formed in other manners.

Referring to FIG. 3E, subsequent to one or more operations that result in the cross-section shown in FIG. 3D, an etch is performed to remove DFR material 321, excess metals and excess parts of the nanocube layer 317. In an embodiment, the etch can be performed by isotropic, anisotropic, plasma etching, ion milling or sputter etching.

Referring to FIG. 3F, subsequent to one or more operations that result in the cross-section shown in FIG. 3E, the thin film capacitor that is formed by the foregoing operations is embedded by the formation of an insulating film structure 331. Thereafter, conductor via 325, conductor via 327, conductor layer 329a and conductor layer 329b are formed.

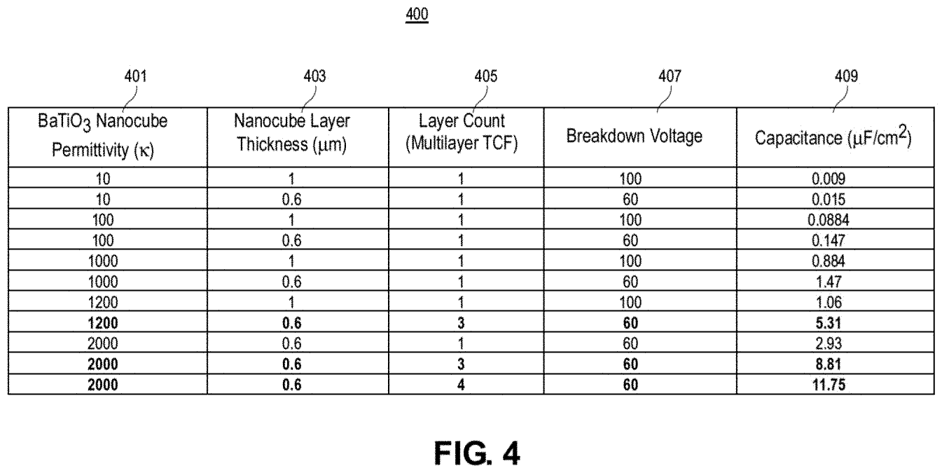

FIG. 4 illustrates a table 400 of example capacitances per unit area for a sample geometry according to an embodiment. In an embodiment the table 400 includes columns that show, for a range of capacitances, permittivity 401, thickness 403, layer count 405, breakdown voltage 407, and capacitance 409.

Referring to FIG. 4, in an embodiment, the range of BaTiO₃ permittivity can be from 10-1200. In the FIG. 4 example, a TFC surface area (litho-defined) with a 20×10 mm cavity and a thickness that varies from 600-1000 nm were used (where 200 nm BaTiO₃ nanocubes can be stacked in sets of 3-6). These values yielded capacitances ranging from 1.47-2.93 μF/cm² for a single TFC. The capacitance values are related to the capacitance of crystalline BaTiO₃, the ability to grow a very thin film, and the large surface area that can be patterned. In an embodiment, a stacked arrangement of three TFCs provided capacitances that ranged from 5.31-11.75 μF/cm². In an embodiment, for an operating voltage of 10V, energy density can be significantly increased. The breakdown voltages for various film thicknesses are shown in the next to last column of the table 400. The lowest value illustrates the worst-case scenario (100 kV/mm). In the table 400, the maximum operating voltages are much higher (40-60 V range) than those expected for most packages (4-8 V range). Accordingly, in an embodiment, the TFCs described herein are usable with expected operating voltage targets. However, in an embodiment, higher operating voltages can be used to increase capacitance.

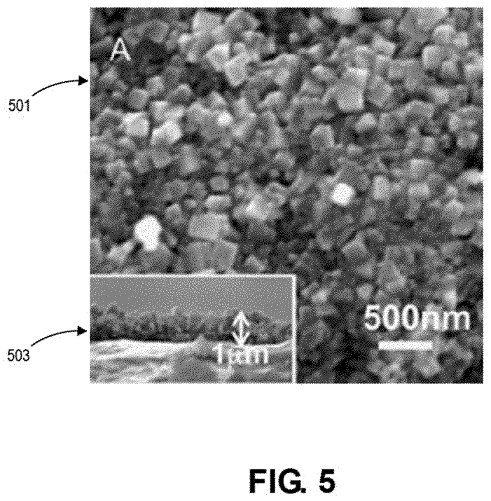

FIG. 5 illustrates the morphology and structure of nanocube material according to an embodiment. FIG. 5 shows nanocube crystals 501 and interface 503.

Referring to FIG. 5, in an embodiment, a cross-section and elemental analysis (EDS or XPS) of the nanocube material, e.g., BaTiO₃, can be used to identify BaTiO₃ crystals. For example, in FIG. 5, the nanocube crystals 501 identified by the letter “A” are clearly visible and thus the nanocube morphology is clearly observable. In addition, nucleation and growth from the titanium interface 503 (a characteristic of the method described herein) are clearly visible with high-resolution scanning electron microscope (SEM) images after cross-section (see image at bottom left corner of FIG. 5).

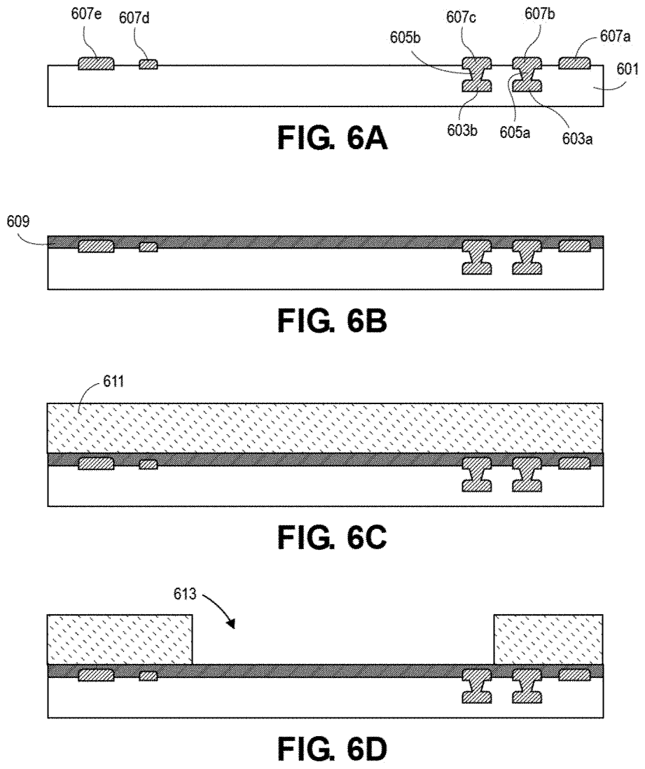

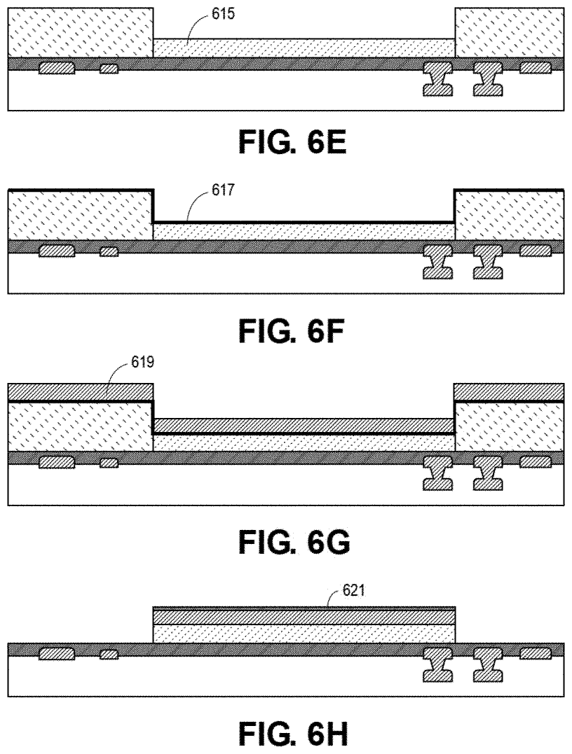

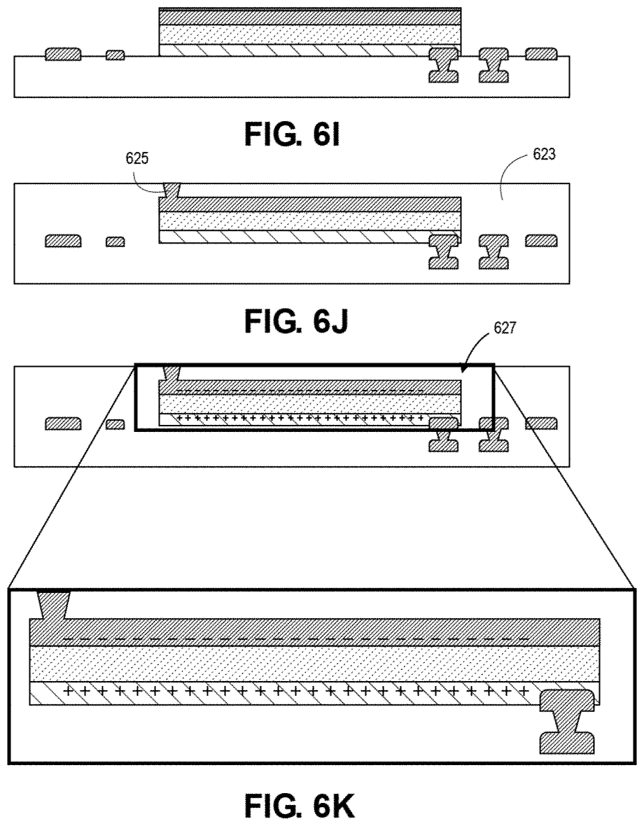

In an embodiment, to address pinholes, a backfill operation, which can include an RF sputter of a thin layer of SiN (˜5-10 nm), can be performed after the nanocube layer is formed. It should be noted that although the backfill operation can affect the capacitance of the TFC, it can be used effectively to decrease the risk of shorting. It should be appreciated the capacitance values are very high for the nanocube materials described herein and decreases in capacitance should be nominal. FIGS. 6A-6K illustrate a process that includes a backfill operation for addressing pinholes according to an embodiment. It should be noted that in an embodiment, a roughening step can be added to the operation associated with FIG. 6G in order to assist with DFR lift-off.

Referring to FIG. 6A, subsequent to one or more operations, the initial structure includes insulating film structure 601, conductor layer 603a, conductor layer 603b, conductor via 605a, conductor via 605b, conductor layer 607a, conductor layer 607b, conductor layer 607c, conductor layer 607d, and conductor layer 607e.

Referring to FIG. 6B, subsequent to one or more operations that result in the cross-section shown in FIG. 6A, a blanket titanium film 609 is formed on the insulating film structure 601 and above the conductor layer 607a, the conductor layer 607b, the conductor layer 607c, the conductor layer 607d. In an embodiment, the titanium film 609 can be formed by sputtering. In other embodiments, the titanium film 609 can be formed in other manners. In an embodiment, the titanium film 609 can form a bottom electrode and a substrate for a nanocube layer formation.

Referring to FIG. 6C, subsequent to one or more operations that result in the cross-section shown in FIG. 6B, a dry film resist layer 611 is formed on the Ti film 609. In an embodiment, the dry film resist layer 611 can be formed by atomic layer deposition (ALD), physical vapor deposition (PVD), chemical vapor deposition (CVD), electrochemical deposition (ECD), or molecular beam epitaxy (MBE). In other embodiments, the dry film resist layer 611 can be formed in other manners.

Referring to FIG. 6D, subsequent to one or more operations that result in the cross-section shown in FIG. 6C, a space 613 in the dry film resist layer 611 is formed. In an embodiment, the space 613 is formed to accommodate the capacitor. In an embodiment, the space 613 can be formed in the dry film resist layer 611 by etching. In an embodiment, the space 613 can be formed by isotropic, anisotropic, plasma etching, ion milling or sputter etching.

Referring to FIG. 6E, subsequent to one or more operations that result in the cross-section shown in FIG. 6D, a nanocube material layer 615 is formed on the titanium film 609 in the space 613 in the dry film resist layer 611. In an embodiment, the nanocube material layer 615 can be formed by electroless growth. In other embodiments, the nanocube material layer 615 can be formed in other manners.

Referring to FIG. 6F, subsequent to one or more operations that result in the cross-section shown in FIG. 6E, an ultrathin dielectric layer 617 is formed on the nanocube material layer 615. In an embodiment, the ultrathin dielectric layer 617 can be formed by RF sputtering in order to backfill gaps in the nanocube material layer 615 to prevent shorts. In other embodiments, the ultrathin dielectric layer 617 can be formed in other manners to backfill gaps in the nanocube material layer 615 to prevent shorts. In an embodiment, an ABF layer can be formed to backfill gaps in the nanocube material layer 615 to prevent shorts. In an embodiment, the ABF layer can be formed by spraying. In other embodiments, the ABF layer can be formed in other manners.

Referring to FIG. 6G, subsequent to one or more operations that result in the cross-section shown in FIG. 6F, a thin film conductor 619 is formed on the ultrathin dielectric layer 617 to form a top plate. In an embodiment, the thin film conductor 619 can be formed from copper. In other embodiments, the thin film conductor 619 can be formed from other materials. In an embodiment, the thin film conductor 619 can be formed by sputtering. In other embodiments, the thin film conductor 619 can be formed in other manners.

Referring to FIG. 6H, subsequent to one or more operations that result in the cross-section shown in FIG. 6G, the DFR layer 611 and excess conductor material is removed. In an embodiment, the DFR layer 611 and the excess conductor material can be removed by etching. In an embodiment, the DFR layer 611 and the excess conductor material can be removed by isotropic, anisotropic, plasma etching, ion milling or sputter etching.

Referring to FIG. 6I, subsequent to one or more operations that result in the cross-section shown in FIG. 6H, the titanium layer 609 is selectively etched. Referring to FIG. 6J, subsequent to one or more operations that result in the cross-section shown in FIG. 6I, an insulating film structure 623 is formed on the structure and a conductor via 625 is formed in the insulating film structure 623. In an embodiment, the conductor via 625 can be formed to make a connection to the capacitor top plate.

Referring to FIG. 6K, an enlarged view of the completed thin film capacitor 627 is shown with the capacitor zone identified.

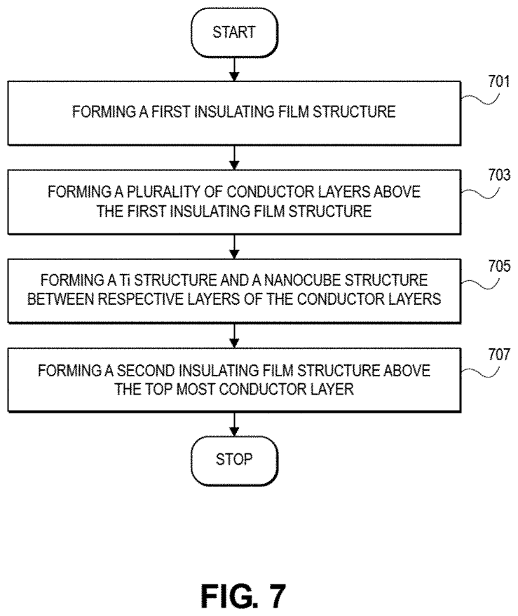

FIG. 7 illustrates a flowchart of a method for forming an embedded thin film capacitor according to an embodiment. The method includes, at 701, forming a first insulating film structure. At 703, forming a plurality of conductor layers above the first insulating film structure. At 705, forming a titanium structure and a nanocube structure between respective layers of the plurality of conductor layers. In an embodiment, the nanocube structure is formed above the titanium structure. At 707, forming a second insulating film structure above a topmost conductor layer of the plurality of conductor layers. In an embodiment, the nanocube structure includes BaTiO₃. In other embodiments, the nanocube structure includes other materials. In an embodiment, the titanium structure and the nanocube structure between respective layers of the plurality of conductor layers include an undercut region. In an embodiment, a width of respective conductor layers decreases in a direction from bottom to top. In an embodiment, a width of respective conductor layers of the plurality of conductor layers decreases by at least 5-500 micrometers in a direction from bottom to top. In an embodiment, the device includes a thin film capacitor that includes a capacitance between 2.93 uF/cm² and 11.75 uF/cm². In an embodiment, a permittivity of the nanocube structure is greater than 5000. In an embodiment, the nanocube structure has a thickness of 100-1400 nm.

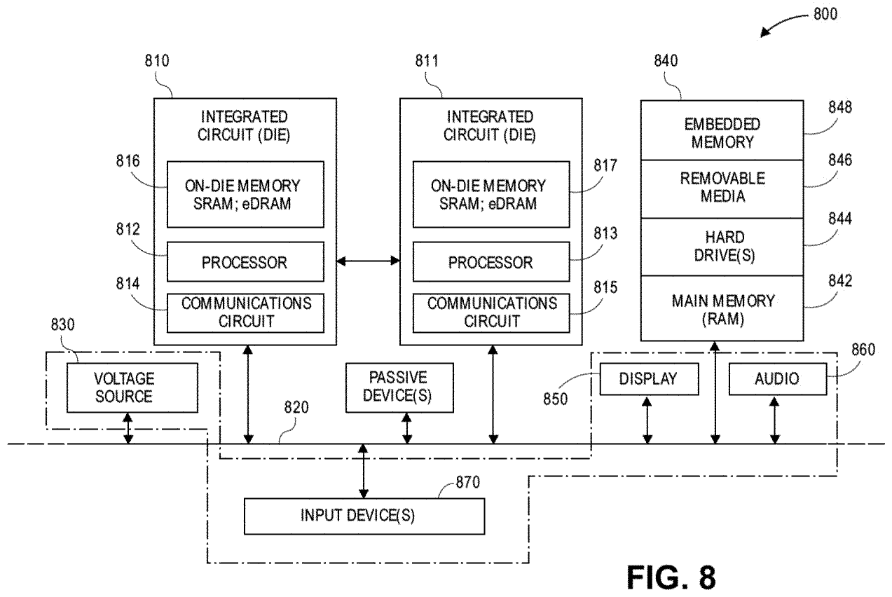

FIG. 8 is a schematic of a computer system 800, in accordance with an embodiment of the present invention. The computer system 800 (also referred to as the electronic system 800) as depicted can include embedded thin film capacitors (e.g., 100 in FIG. 1), according to any of the several disclosed embodiments and their equivalents as set forth in this disclosure. The computer system 800 may be a mobile device such as a netbook computer. The computer system 800 may be a mobile device such as a wireless smart phone. The computer system 800 may be a desktop computer. The computer system 800 may be a hand-held reader. The computer system 800 may be a server system. The computer system 800 may be a supercomputer or high-performance computing system.

In an embodiment, the electronic system 800 is a computer system that includes a system bus 820 to electrically couple the various components of the electronic system 800. The system bus 820 is a single bus or any combination of busses according to various embodiments. The electronic system 800 includes a voltage source 830 that provides power to the integrated circuit die 810. In an embodiment, the computer system 800 can include a plurality of integrated circuit die 810 that can include one or more embedded thin film capacitors such are a part of the thin film capacitor structure 100 that is described with reference to FIG. 1. In some embodiments, the voltage source 830 supplies current to the integrated circuit 810 through the system bus 820.

The integrated circuit 810 is electrically coupled to the system bus 820 and includes any circuit, or combination of circuits according to an embodiment. In an embodiment, the integrated circuit 810 includes a processor 812 that can be of any type. As used herein, the processor 812 may mean any type of circuit such as, but not limited to, a microprocessor, a microcontroller, a graphics processor, a digital signal processor, or another processor. In an embodiment, the processor 812 includes, or is coupled with, interconnects that can include a Ti layer/Cu interfacial layer for providing adhesion with organic dielectric material, as disclosed herein. In an embodiment, SRAM embodiments are found in memory caches of the processor. Other types of circuits that can be included in the integrated circuit 810 are a custom circuit or an application-specific integrated circuit (ASIC), such as a communications circuit 814 for use in wireless devices such as cellular telephones, smart phones, pagers, portable computers, two-way radios, and similar electronic systems, or a communications circuit for servers. In an embodiment, the integrated circuit 810 includes on-die memory 816 such as static random-access memory (SRAM). In an embodiment, the integrated circuit 810 includes embedded on-die memory 816 such as embedded dynamic random-access memory (eDRAM).

In an embodiment, the integrated circuit 810 is complemented with a subsequent integrated circuit 811. Useful embodiments include a dual processor 813 and a dual communications circuit 815 and dual on-die memory 817 such as SRAM. In an embodiment, the dual integrated circuit 810 includes embedded on-die memory 817 such as eDRAM.

In an embodiment, the electronic system 800 also includes an external memory 840 that in turn may include one or more memory elements suitable to the particular application, such as a main memory 842 in the form of RAM, one or more hard drives 844, and/or one or more drives that handle removable media 846, such as diskettes, compact disks (CDs), digital variable disks (DVDs), flash memory drives, and other removable media known in the art. The external memory 840 may also be embedded memory 848 such as the first die in a die stack, according to an embodiment.

In an embodiment, the electronic system 800 also includes a display device 850, an audio output 860. In an embodiment, the electronic system 800 includes an input device such as a controller 870 that may be a keyboard, mouse, trackball, game controller, microphone, voice-recognition device, or any other input device that inputs information into the electronic system 800. In an embodiment, an input device 870 is a camera. In an embodiment, an input device 870 is a digital sound recorder. In an embodiment, an input device 870 is a camera and a digital sound recorder.

As shown herein, the thin film capacitor structure 100 (FIG. 1) can be implemented in a number of different embodiments, including on die memory that can utilize capacitors, according to any of the several disclosed embodiments and their equivalents, an electronic system, a computer system, one or more methods of fabricating an integrated circuit, and one or more methods of fabricating an electronic assembly, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates. A foundation substrate may be included, as represented by the dashed line of FIG. 8. The capacitors of embedded thin film capacitor structure 100 (FIG. 1) can be used as passive devices, as is also depicted in FIG. 8.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of the present application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The following examples pertain to further embodiments. The various features of the different embodiments may be variously combined with some features included and others excluded to suit a variety of different applications.

Example embodiment 1: A device, comprising: a first insulating film structure; a plurality of conductor layers above the first insulating film structure; a Ti structure and a nanocube structure between respective layers of the plurality of conductor layers, the nanocube structure above the Ti structure; and a second insulating film structure above a topmost conductor layer of the plurality of conductor layers.

Example embodiment 2: The device of example embodiment 1, wherein the nanocube structure includes BaTiO₃.

Example embodiment 3: The device of example embodiment 1 or 2, wherein the Ti structure and the nanocube structure between respective layers of the plurality of conductor layers include an undercut region.

Example embodiment 4: The device of example embodiment 1, 2, or 3, wherein a width of respective conductor layers of the plurality of conductor layers decreases in a direction from bottom to top.

Example embodiment 5: The device of example embodiment 1, 2, 3, or 4, wherein a width of respective conductor layers of the plurality of conductor layers decreases by at least 5-500 micrometers in a direction from bottom to top.

Example embodiment 6: The device of example embodiment 1, 2, 3, 4, or 5, wherein the device includes a thin film capacitor that includes a capacitance between 2.93 uF/cm² and 11.75 uF/cm².

Example embodiment 7: The device of example embodiment 1, 2, 3, 4, 5, or 6, wherein a permittivity of the nanocube structure is greater than 5000.

Example embodiment 8: The device of example embodiment 1, 2, 3, 4, 5, 6, or 7, wherein the nanocube structure has a thickness of 100-1400 nm.

Example embodiment 9: The device of example embodiment 1, 2, 3, 4, 5, 6, 7, or 8, wherein the Ti layer has a thickness of 200-600 nm.

Example embodiment 10: A device, comprising: a first insulating film structure; a Ti structure on the first insulating film structure; a nanocube structure on the Ti structure; a dielectric structure on the nanocube structure; a conductor layer on the dielectric structure; and a second insulating film structure above the conductor layer.

Example embodiment 11: The device of example embodiment 10, wherein the nanocube structure includes BaTiO₃.

Example embodiment 12: The device of example embodiment 10, or 11, wherein the device includes a thin film capacitor that includes a capacitance between 2.93 uF/cm² and 11.75 uF/cm².

Example embodiment 13: The device of example embodiment 10, 11, or 12, wherein a permittivity of the nanocube structure is greater than 5000.

Example embodiment 14: The device of example embodiment 10, 11, 12, or 13, wherein the nanocube structure has a thickness of 100-1400 nm.

Example embodiment 15: The device of example embodiment 10, 11, 12, 13, or 14, wherein a thickness of the dielectric structure is less than 5 nm.

Example embodiment 16: A system, comprising: one or more processing components; and one or more data storage components, the data storage components including at least one device, the at least one device including: a first insulating film structure; a plurality of conductor layers above the first insulating film structure; a Ti structure and a nanocube structure between respective layers of the plurality of conductor layers, the nanocube structure above the Ti structure; and a second insulating film structure above a topmost conductor layer of the plurality of conductor layers.

Example embodiment 17: The system of example embodiment 16, wherein the nanocube structure includes BaTiO₃.

Example embodiment 18: A method, comprising: forming a first conductor layer; forming a Ti layer on the first conductor layer; forming a nanocube layer on the Ti layer; forming a second conductor layer; forming a DFR lamination on a portion of the second conductor layer; in a space in the DFR lamination, plating up conductor material above the second conductor layer to form a top plate of a capacitor; performing a DFR strip of the DFR lamination; performing an etch to remove a seed material; performing an etch to remove a portion of the nanocube layer; performing an etch to remove a portion of the nanocube layer; and forming a second insulating film structure on the second conductor layer.

Example embodiment 19: The method of example embodiment 18, wherein the forming the first conductor layer and the forming the second conductor layer includes forming the first conductor layer and forming the second conductor layer from copper.

Example embodiment 20: The method of example embodiment 18, or 19, wherein the forming the nanocube layer includes forming the nanocube layer using BaTiO₃.

Example embodiment 21: The method of example embodiment 18, 19, or 20, wherein the forming the Ti layer includes forming the Ti layer by sputtering.

Example embodiment 22: The method of example embodiment 18, 19, 20, or 21, wherein the forming the nanocube layer includes forming the nanocube layer electrolessly.

Example embodiment 23: The method of example embodiment 18, 19, 20, 21, or 22, wherein the plating up of the conductor material includes plating up the conductor material using electrolytic plating.

Example embodiment 24: The method of example embodiment 18, 19, 20, 21, 22, or 23, wherein the performing the etch includes performing a selective etch to remove a portion of the nanocube layer and includes using an approximately 15 degree Celsius, one molar, HCl immersion selective etch.

Example embodiment 25: The method of example embodiment 18, 19, 20, 21, 22, 23, or 24, wherein the performing the etch includes performing a selective etch to remove a portion of the Ti layer and includes using a peroxide and HCl etch mixture, that leaves the nanocube layer intact.

Example embodiment 26: The method of example embodiment 18, 19, 20, 21, 22, 23, 24, or 25, wherein the Ti structure and the nanocube structure between respective layers of the plurality of conductor layers include an undercut region.

Example embodiment 27: A method, comprising: forming a first insulating film layer; forming a Ti layer on the first insulating film layer; forming dry film resist on the Ti layer; forming a space in the dry film resist; forming a nanocube layer on the Ti layer in the space; forming a conductor layer on the nanocube layer; removing the dry film resist and material on the dry film resist; selectively etching the Ti layer; and forming a second insulating film on the second conductor layer.

Example embodiment 28: The method of example embodiment 27, further comprising forming a dielectric layer above the nanocube layer.

Example embodiment 29: The method of example embodiment 27, wherein the forming the conductor layer includes forming the conductor layer from copper.

Example embodiment 30: The method of example embodiment 27, 28, or 29, wherein the forming the nanocube layer includes forming the nanocube layer using BaTiO₃.

Example embodiment 31: The method of example embodiment 27, 28, 29, or 30, wherein the forming the Ti layer includes forming the Ti layer by sputtering.

Example embodiment 32: The method of example embodiment 27, 28, 29, 30, or 31, wherein the forming the nanocube layer includes forming the nanocube layer electrolessly.

Example embodiment 33: A method, comprising: forming a first insulating film structure; forming a plurality of conductor layers above the first insulating film structure; forming a Ti structure and a nanocube structure between respective layers of the plurality of conductor layers, the nanocube structure above the Ti structure; and forming a second insulating film structure above a topmost conductor layer of the plurality of conductor layers.

Example embodiment 34: The method of example embodiment 33, wherein the nanocube structure includes BaTiO₃.

Example embodiment 35: The method of example embodiment 33, or 34, wherein the Ti structure and the nanocube structure between respective layers of the plurality of conductor layers include an undercut region.

Example embodiment 36: The method of example embodiment 33, 34, or 35, wherein a width of respective conductor layers of the plurality of conductor layers decreases in a direction from bottom to top.

Example embodiment 37: The method of example embodiment 33, 34, 35, or 36, wherein a width of respective conductor layers of the plurality of conductor layers decreases by at least 5-500 micrometers in a direction from bottom to top.

Example embodiment 38: The method of example embodiment 33, 34, 35, 36, or 37, wherein the device includes a thin film capacitor that includes a capacitance between 2.93 uF/cm² and 11.75 uF/cm².

Example embodiment 39: The method of example embodiment 33, 34, 35, 36, 37, or 38, wherein a permittivity of the nanocube structure is greater than 5000.

Example embodiment 40: The method of example embodiment 33, 34, 35, 36, 37, 38, or 39, wherein the nanocube structure has a thickness of 100-1400 nm.

Example embodiment 41: The method of example embodiment 33, 34, 35, 36, 37, 38, 39, or 40, wherein the Ti layer has a thickness of 200-600 nm.

What is claimed is:

1. A device, comprising:
a first insulating film structure;
a plurality of conductor layers above the first insulating film structure;
a Ti structure and a nanocube structure between respective layers of the plurality of conductor layers, the nanocube structure above the Ti structure; and
a second insulating film structure above a topmost conductor layer of the plurality of conductor layers.

2. The device of claim 1, wherein the nanocube structure includes BaTiO₃.

3. The device of claim 1, wherein the Ti structure and the nanocube structure between respective layers of the plurality of conductor layers include an undercut region.

4. The device of claim 1, wherein a width of respective conductor layers of the plurality of conductor layers decreases in a direction from bottom to top.

5. The device of claim 1, wherein a width of respective conductor layers of the plurality of conductor layers decreases by at least 5-500 micrometers in a direction from bottom to top.

6. The device of claim 1, wherein the device includes a thin film capacitor that includes a capacitance between 2.93 uF/cm² and 11.75 uF/cm².

7. The device of claim 1, wherein a permittivity of the nanocube structure is greater than 5000.

8. The device of claim 1, wherein the nanocube structure has a thickness of 100-1400 nm.

9. The device of claim 1, wherein the Ti layer has a thickness of 200-600 nm.

10. A device, comprising:
a first insulating film structure;
a Ti structure on the first insulating film structure;
a nanocube structure on the Ti structure;
a dielectric structure on the nanocube structure;
a conductor layer on the dielectric structure; and
a second insulating film structure above the conductor layer.

11. The device of claim 10, wherein the nanocube structure includes BaTiO₃.

12. The device of claim 10, wherein the device includes a thin film capacitor that includes a capacitance between 2.93 uF/cm² and 11.75 uF/cm².

13. The device of claim 10, wherein a permittivity of the nanocube structure is greater than 5000.

14. The device of claim 10, wherein the nanocube structure has a thickness of 100-1400 nm.

15. The device of claim 10, wherein a thickness of the dielectric structure is less than 5 nm.

16. A system, comprising:
one or more processing components; and
one or more data storage components, the data storage components including at least one device, the at least one device including:
a first insulating film structure;
a plurality of conductor layers above the first insulating film structure;
a Ti structure and a nanocube structure between respective layers of the plurality of conductor layers, the nanocube structure above the Ti structure; and
a second insulating film structure above a topmost conductor layer of the plurality of conductor layers.

17. The system of claim 16, wherein the nanocube structure includes BaTiO₃.

18. A method, comprising:
forming a first conductor layer;
forming a Ti layer on the first conductor layer;
forming a nanocube layer on the Ti layer;
forming a second conductor layer;
forming a dry film resist (DFR) lamination on a portion of the second conductor layer;
in a space in the DFR lamination, plating up conductor material above the second conductor layer to form a top plate of a capacitor;
performing a DFR strip of the DFR lamination;
performing an etch to remove a seed material;
performing an etch to remove a portion of the nanocube layer;
performing an etch to remove a portion of the nanocube layer; and
forming a second insulating film structure on the second conductor layer.

19. The method of claim 18, wherein the forming the first conductor layer and the forming the second conductor layer includes forming the first conductor layer and forming the second conductor layer from copper.

20. The method of claim 18, wherein the forming the nanocube layer includes forming the nanocube layer using BaTiO₃.

21. The method of claim 18, wherein the forming the Ti layer includes forming the Ti layer by sputtering.

22. The method of claim 18, wherein the forming the nanocube layer includes forming the nanocube layer electrolessly.

23. The method of claim 18, wherein the plating up of the conductor material includes plating up the conductor material using electrolytic plating.

24. The method of claim 18, wherein the performing the etch includes performing a selective etch to remove a portion of the nanocube layer and includes using an approximately 15 degrees Celsius, one molar, HCl immersion selective etch.

25. The method of claim 18, the performing the etch includes performing a selective etch to remove a portion of the Ti layer and includes using a peroxide and HCl etch mixture, that leaves the nanocube layer intact.
